(19) United States
(12) Patent Application Publication
(10) Pub. No.: US 2005/0250873 A1
(43) Pub. Date: Nov. 10, 2005

(54) Compositions and process for inhibiting the movement of free flowing particles

(76) Inventors: Joseph R. Fox, Dublin, OH (US); Donald S. Mueller, Mundelein, IL (US); Timothy R. Tufts, Powell, OH (US)

Correspondence Address: David L. Hedden;Ashland Inc., P.O. Box 2219, Columbus, OH, 43216, US

(21) Appl. No.: 11/040,484

(22) Filed: Jan. 21, 2005

Related U.S. Application Data
(60) Provisional application No. 60/540,203, filed on Jan. 29, 2004.

(51) Int. Cl. C09K 17/00

(52) U.S. Cl. 523/132

(57) ABSTRACT

The invention relates to compositions and a process for inhibiting the movement of free flowing particles. The process comprises adding a mixture of (a) an ethylenically unsaturated monomer, an ethylenically unsaturated polymer, and mixtures thereof, and (b) a free radical initiator to the free flowing particles which are to be immobilized.

### CROSS-REFERENCE TO RELATED APPLICATIONS

This application is a utility application based upon provisional application 60/540,203 filed on Jan. 29, 2004.

### CLAIM TO PRIORITY

Applicants claim the priority date of provisional application Ser. No. 60/540,203 filed on Jan. 29, 2004, which is hereby incorporated by reference.

### FIELD OF THE INVENTION

The invention relates to compositions and a process for inhibiting the movement of free flowing particles. The process comprises adding a mixture of (a) an ethylenically unsaturated monomer, an ethylenically unsaturated polymer, and mixtures thereof, and (b) a free radical initiator to the free flowing particles which are to be immobilized.

### BACKGROUND OF THE INVENTION

Experience during military and civilian operations in deserts has shown that there is a need to immobilize the particles of sand on the surface of the desert, which are blown due to natural causes, such as wind, or man-made causes, such as a helicopter or an airplane. If the sand is not immobilized, it can be blown into the eyes of personnel on the ground, which could damage the eyes, or into operation equipment, e.g. aircraft engines, helicopter blades, etc., which results in foreign object damage (FOD) and/or damage to the equipment due to erosion. Operations are often interrupted when these circumstances occur. If the sand were immobilized, these hazards could be prevented, and operations could proceed without interruption.

It is known that sand can be shaped into molds and cores used in the casting of metals by the cold-box process, using an ethylenically unsaturated monomer and/or polymer, preferably in conjunction with an acid curable epoxy resin, in the presence of a free radical initiator and sulfur dioxide gas. The ethylenically unsaturated monomer and/or polymer and free radical initiator must be kept separate before they are applied to sand. Otherwise, they may prematurely react, which will prevent the sand from being used effectively to make cores and/or molds. The components are applied to the foundry aggregate (typically sand), which is used to make the cores and/or molds. After the components of the binder and the sand are mixed, the mixture is shaped, exposed to sulfur dioxide gas and allowed to cure. It is not practical to immobilize porous particles covering a vast surface area while they are in place by this method.

### SUMMARY OF THE INVENTION

The invention relates to compositions and a process for inhibiting the movement of free flowing particles. The process comprises adding a mixture of (a) an ethylenically unsaturated monomer, an ethylenically unsaturated polymer, and mixtures thereof, and (b) a free radical initiator to the free flowing particles which are to be immobilized. The amount of (b) is typically 0.5 to 5.0% based on the weight of (a), preferably 0.5 to 2.5%.

“Free flowing particles” are particles that are actually free flowing or particles that have the potential to be free flowing when subjected to wind, rain, or other forces, whether they are man-made or natural.

The use of such flow inhibitors is particularly useful in inhibiting the flow of desert sand, which enables military and civilian operations in deserts to proceed without distraction and interruption. The flow inhibitors fill the spaces between the sand particles, and when the flow inhibitor cures, the sand is immobilized. The desert sand is immobilized from movement due to natural causes, such as wind, or man-made causes, such as a helicopter or an airplane. When the sand is immobilized, visibility problems for people on the ground or in aircraft are minimized, and the disruption of operations is minimized.

The flow inhibitors are applied to the free flowing particles in a manner, which will partially, but preferably totally immobilize the movement of the particles. For example, the particles can be impregnated or sprayed with the flow inhibitor. The flow inhibitors do not need to be mixed with the particles with mixing equipment in order for them to be effective in immobilizing the sand.

### DETAILED DESCRIPTION OF THE INVENTION

The detailed description and examples will illustrate specific embodiments of the invention will enable one skilled in the art to practice the invention, including the best mode. It is contemplated that many equivalent embodiments of the invention will be operable besides these specifically disclosed.

The process comprises adding a mixture of (a) an ethylenically unsaturated monomer, an ethylenically unsaturated polymer, and mixtures thereof, and (b) a free radical initiator to the free flowing particles which are to be immobilized.

Examples of ethylenically unsaturated monomers include acrylates, methacrylates, and aromatic compounds with unsaturated substituents, particularly styrene. Examples of acrylates include a variety of monofunctional, difunctional, trifunctional, tetrafunctional and pentafunctional monomeric acrylates and methacrylates. Representative examples include alkyl acrylates, alkyl methacrylates, and difunctional monomeric acrylates. Other acrylates, which can be used include trimethylolpropane triacrylate, pentaerythritol tetraacrylate, methacrylic acid and 2-ethylhexyl methacrylate. Examples of aromatic monomers include styrene, vinyl toluene, divinyl benzene and alpha-methyl styrene.

Typical reactive unsaturated acrylic polymers, which may also be used, include epoxy/acrylate reaction products, polyester/urethane/acrylate reaction products, acrylated urethane oligomers, polyether acrylates, polyester acrylates, and acrylated epoxy resins.

Preferably used as the ethylenically unsaturated polymers are unsaturated polyester resins. Unsaturated polyester resins are the polycondensation reaction products of one or more dihydric alcohols and one or more unsaturated polycarboxylic acids. The term “unsaturated polycarboxylic acid” is meant to include unsaturated polycarboxylic and dicarboxylic acids; unsaturated polycarboxylic and dicarboxylic anhydrides; unsaturated polycarboxylic and dicarboxylic acid halides; and unsaturated polycarboxylic and dicarboxylic esters. Specific examples of unsaturated polycarboxylic acids include maleic anhydride, maleic acid, and fumaric acid. Mixtures of unsaturated polycarboxylic acids and saturated polycarboxylic acids may also be used.

Examples of suitable unsaturated polyesters include any of the polycondensation products of glycols and an unsaturated diacid or anhydride. The glycols may include (but are not limited to) such compounds as 1,2-propanediol, ethyelene glycol, 1,3-propylene glycol, diethylene glycol, dipropylene glycol, neopentyl glycol, etc. The unsaturated diacids or anhydrides are such compounds as maleic anhydride, maleic acid, fumaric acid, itaconic acid, etc. Optionally, these polycondensation products may contain other diacids or anhydrides such as adipic acid, isophthalic acid, terephthalic acid, and the like. In addition to the above-described polyester one may also use dicyclopentadiene modified unsaturated polyester resins. In addition, reactive resins known as vinyl esters may also be used. These resins are generally the reaction product of an ethylenically unsaturated mono-acid (such as methacrylic acid) and various epoxy resins, which may be di- or multi-functional. Typically, these vinyl esters are the reaction product of methacrylic acid and a glycidyl ether of a multifunctional phenol-formaldehayde resin.

The average molecular weight of the unsaturated polyester used in the process is from about 600 to about 5,000, and more preferably, from about 1000-3500.

The free radical initiator (b) is a peroxide and/or hydroperoxide. Examples include ketone peroxides, peroxy ester free radical initiators, alkyl oxides, chlorates, perchlorates, and perbenzoates. Preferably, however, the free radical initiator is a hydroperoxide or a mixture of peroxide and hydroperoxide. Hydroperoxides particularly preferred in the invention include t-butyl hydroperoxide, cumene hydroperoxide, paramenthane hydroperoxide, etc. The organic peroxides may be aromatic or alkyl peroxides. Examples of useful diacyl peroxides include benzoyl peroxide, lauroyl peroxide and decanoyl peroxide. Examples of alkyl peroxides include dicumyl peroxide and di-t-butyl peroxide.

Various compounds may also be used to accelerate the curing reaction, such as metal complexes and salts (cobalt naphthenate, etc), tertiary aromatic amines (N,N-dimethyl aniline), acetylacetonate, and the like.

The ethylenically unsaturated monomer and/or polymer and free radical initiator are mixed together and then applied to the sand to be immobilized. When both a monomer and polymer are used, the weight ratio of polymer to monomer typically ranges from 1:3 to 4:1, preferably from 1:1 to 3:1.

The amount of flow inhibitor used is an amount sufficient to substantially or completely immobilize the surface of the sand for a time sufficient to carry out the operations without disruption. Generally, the amount of flow inhibitor required will be 0.5 to 5.0 pounds per square foot, preferably 1 to 3 pounds per square foot, or 2.5 to 25 kilograms per square meter, preferably 5 to 15 kilograms per square meter.

Although the flow inhibitor can be used to immobilize any particulate solid, it is particularly useful for immobilizing sand particles, e.g. zircon, olivine, aluminosilicate, chromite sand, and the like. It is also useful for immobilizing mixtures that contain sand and clay.

The amount of sand immobilized by the flow inhibitor is greatest when all of the flow inhibitor penetrates into the spaces between the sand particles before curing occurs. If curing occurs before penetration is completed, a layer of cured resin will form on top of the sand, and less sand will be immobilized.

To avoid this, the viscosity and the curing time of the flow inhibitor need to be correctly adjusted. The examples illustrate several ways this can be achieved. For example, if curing occurs before all of the flow inhibitor has a chance to penetrate spaces between the sand particles, additional solvent can be added to lower the viscosity of the flow inhibitor, thereby enabling the flow inhibitor to penetrate between the spaces of the sand particles more quickly. The ability to balance viscosity and cure speed will depend upon the particular system and solid particulate to be immobilized, but the approaches described above will be appreciated by those skilled in the art.

Although the viscosity of the flow inhibitor can vary over wide ranges, typically a good balance of penetration and cure speed can be achieved with a representative sand when the flow inhibitor has a viscosity less than 250 centipoise at 25° C., preferably less than 100 centipoise, and most preferably less than 50 centipoise. The viscosity of the flow inhibitor can be adjusted by adding more monomer.

### ABBREVIATIONS AND/OR DEFINITIONS

The following abbreviations and/or definitions are used in the examples:
RESIN UPE resin LB 1101-06, an unsaturated polyester resin supplied by Ashland Specialty Chemical Company, a division of Ashland Inc. This resin is a mixture of an unsaturated polyester (made up of the condensation product from propylene and diethylene glycols, and phthalic and maleic anhydrides) dissolved in styrene. The ratio of resin to monomer is about 57:43, and has a viscosity of about 90 cps at room temperature.
MEKO methylethyl ketone peroxide, a free radical initiator.

### EXAMPLES

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application, all units are in the metric system and all amounts and percentages are by weight, unless otherwise expressly indicated.

In the examples, the sand used was 100 grams of lake sand (Manley 1L5W).

### Example 1

### Impregnation with an Unsaturated Polyester Resin and a Free Radical Initiator

The RESIN and MEKO were combined to form the flow inhibitor. Forty grams of RESIN were mixed with 0.6 grams MEKO (1.5% based on the weight of resin). Fifteen grams of the mixture were added to 100 grams of sand in a 3 ounce cup. The flow inhibitor cured within 5 minutes, before all of it had a chance to penetrate into the sand.

The surface and subsurface of the sand became noticeably harder with time, because the spaces between the sand particles had been penetrated and the flow inhibitor had cured. The sample was allowed to cure for two hours, and the immobilized sand was recovered. The weight of immobilized sand was determined as follows:
Weight of immobilized sand=(weight of cured sand+resin)−(weight of resin added to sand)

In this case, the amount of immobilized sand was 47.7 grams.

The resin-immobilized sand had good very structural integrity, which indicates that the sand particles were immobilized.

### Example 2

### Impregnation with an Unsaturated Polyester Resin and a Lower Level of Free Radical Initiator

Example 1 was repeated, except a smaller amount of free radical initiator was used.

Forty grams of RESIN were mixed with 0.3 grams MEKO (0.75% based on the weight of resin). The viscosity of this mixture was 77 centipoise. Fifteen grams of the mixture were added to the sand. All of the flow inhibitor penetrated into the sand before curing occurred.

After 10 minutes, the surface of the sand became noticeably harder, because the spaces between the sand particles had been penetrated and the flow inhibitor had cured. This trend continued with time. The sample was allowed to cure for 2.5 hours, and the immobilized sand was recovered.

In this case, the amount of immobilized sand was 64.4 grams.

The resin-immobilized sand had good very structural integrity, which indicates that the sand particles were immobilized. In this example, there was no layer of cured resin on top of the sand, and a significantly higher yield of immobilized sand was obtained than in Example 1.

This example shows that by tailoring the catalyst level, complete penetration of the flow inhibitor can be obtained before curing, resulting in a significant increase in the amount of immobilized sand.

### Example 3

### Impregnation with a Diluted Unsaturated Polyester Resin and a Free Radical Initiator

This example illustrates another method of slowing down the reactivity of the flow inhibitor, so that it can more effectively penetrate the sand before immobilizing it.

The flow inhibitor was formed by using a diluted version of the resin employed in Examples 1 and 2. In this example, the resin was diluted with additional styrene, a reactive monomer that is already present in the resin.

Thirty six grams of RESIN and 4 grams styrene were mixed. 0.6 grams of MEKO was added. The viscosity of this mixture was 40 centipoise. 15 grams of this mixture were impregnated onto sand. All of the flow inhibitor penetrated into the sand before curing occurred.

The surface and subsurface of the sand became noticeably harder with time, because the spaces between the sand particles had been penetrated and the flow inhibitor had cured. This trend continued with time. The sample was allowed to cure for two hours, and the immobilized sand was recovered.

In this case, the amount of immobilized sand was 65.6 grams.

The resin-immobilized sand had good very structural integrity, which indicates that the sand particles were immobilized. In this example, all of the sand was immobilized and there was no layer of cured resin on top of the sand.

This example shows that by diluting the resin with additional monomer, all of the flow inhibitor had a chance to penetrate into the sand before curing occurred. This is attributed to the fact that the viscosity of the flow inhibitor was reduced by the additional monomer, thereby enabling easier penetration into the sand.

TABLE I
(Sumnmary of the results ussing unsaturated polyester flow inhibitors)

| | | Weight of | |
|---|---|---|---|
| Example | Flow Inhibitor | Immobilized sand (grams) | Appearance/properties |
| 1 | RESIN | 47.7 | Layer ogf cured resin |
| | +1.5% MEKO | | on top of sand. |
| 2 | RESIN | 64.4 | No resin layer on top. |
| | +0.75% MEKO | | |
| 3 | (90% RESIN/10% styrene) | 65.6 | No resin layer on top. |
| | 1.5% MEKO | | |

1. A process for inhibiting the movement of free flowing particles, which comprises adding a mixture of (a) an ethylenically unsaturated monomer, an ethylenically unsaturated polymer, and mixtures thereof, and (b) a free radical initiator to the free flowing particles which are to be immobilized, wherein the amount of (b) is from about 0.5 to about 5.0 weight percent based on the weight of (a).

2. The process of claim 1 wherein (a) comprises an unsaturated polyester resin.

3. The process of claim 2 wherein (b) is methylethyl ketone peroxide.

4. The process of claim 3 wherein the amount of (b) is from about 0.5 to about 2.5 weight percent based on the weight of (a).

5. The process of claim 4 wherein the viscosity of (a) is less than about 50 centipoise.

6. The process of claim 5 wherein (a) further comprises styrene.

7. The process of claim 1, 2, 3, 4, 5, or 6 wherein the said particles are sand particles.

8. The process of claim 7 wherein the flow inhibitor is applied to the sand particles by spraying.

9. The process of claim 7 wherein the flow inhibitor is applied by impregnating the sand particles with the flow inhibitor.

10. A mixture comprising (a) an ethylenically unsaturated monomer, an ethylenically unsaturated polymer, and mixtures thereof, and (b) a free radical initiator to the free flowing particles which are to be immobilized, wherein the amount of (b) is from about 0.5 to about 5.0 weight percent based on the weight of (a).

11. The mixture of claim 10 wherein (a) comprises an unsaturated polyester resin.

12. The mixture of claim 11 wherein (b) is methylethyl ketone peroxide.

13. The mixture of claim 12 wherein the amount of (b) is from about 0.5 to about 2.5 weight percent based on the weight of (a).

14. The mixture of claim 13 wherein the viscosity of (a) is less than about 50 centipoise.

15. The mixture of claim 14 wherein (a) further comprises styrene.

16. The mixture of claim 10, 11, 12, 13, 14, or 15, which further comprises free flowing particles.

17. The mixture of claim 16 wherein the free flowing particles comprise sand.
